(19) United States
(12) Patent Application Publication
(10) Pub. No.: US 2021/0245768 A1
(43) Pub. Date: Aug. 12, 2021

(54) INFORMATION PROCESSING APPARATUS, SYSTEM, AND INFORMATION PROCESSING METHOD

(71) Applicant: TOYOTA JIDOSHA KABUSHIKI KAISHA, Toyota-shi (JP)

(72) Inventors: Mitsuyoshi OHNO, Miyoshi-shi (JP); Daiki KUBO, Toyota-shi (JP); Yosuke NOZAKI, Toyota-shi (JP); Tsukasa NAKANISHI, Nagoya-shi (JP); Hironori AOYAMA, Toyota-shi (JP); Seiji YOGO, Nagoya-shi (JP); Tae SUGIMURA, Miyoshi-shi (JP); Yasuhiro KOBATAKE, Nagoya-shi (JP); Takeshi YAMADA, Anjo-shi (JP); Ryo SATO, Nisshin-shi (JP); Sayaka NINOYU, Toyota-shi (JP)

(73) Assignee: TOYOTA JIDOSHA KABUSHIKI KAISHA, Toyota-shi (JP)

(21) Appl. No.: 17/158,600

(22) Filed: Jan. 26, 2021

(30) Foreign Application Priority Data
Feb. 6, 2020 (JP) 2020-018893

(51) Int. Cl. B60W 40/09; B60W 60/00; B60W 40/109; G07C 5/08

(52) U.S. Cl. CPC B60W 40/09; G07C 5/0816; B60W 40/109; B60W 60/001

(57) ABSTRACT

An apparatus includes a control section that performs: acquiring information related to a purpose of use of a passenger cabin part, the purpose of use being intended by a user who rides in the passenger cabin part; and setting a control parameter of a traveling part that carries the passenger cabin part, based on information related to a behavior of the user in the passenger cabin part, and on the information related to the purpose of use intended by the user.

### INCORPORATION BY REFERENCE

The disclosure of Japanese Patent Application No. 2020-018893 filed on Feb. 6, 2020 including the specification, drawings and abstract is incorporated herein by reference in its entirety.

### BACKGROUND

### 1. Technical Field

The disclosure relates to an information processing apparatus, a system, and an information processing method.

### 2. Description of Related Art

There has been known a technology that adjusts a parameter affecting acceleration of a vehicle, based on a vibration allowable to cargo transported by the vehicle (for example, see Japanese Patent Application Publication No. 2019-116251).

### SUMMARY

When a user performs any action in a vehicle, the action of the user may be hindered, depending on a traveling state of the vehicle. An object of the disclosure is to restrain hindering of an action of a user in a vehicle.

An aspect of the present disclosure is an information processing apparatus, including a control section that performs: acquiring information related to a purpose of use of a passenger cabin part, the purpose of use being intended by a user who rides in the passenger cabin part; and setting a control parameter of a traveling part that carries the passenger cabin part, based on information related to a behavior of the user in the passenger cabin part, and on the information related to the purpose of use intended by the user.

Another aspect of the present disclosure is a system, including: a passenger cabin part in which a user rides; a traveling part that is joined to the passenger cabin part and carries the passenger cabin part; and a server that assigns the passenger cabin part and the traveling part to the user, wherein the passenger cabin part includes a sensor that senses a behavior of the user, the traveling part or the server sets a control parameter of the traveling part, depending on information related to the behavior of the user sensed by the sensor, and on information related to a purpose of use intended by the user, and the traveling part performs autonomous traveling based on the control parameter.

Still another aspect of the present disclosure is an information processing method, including: by a computer, acquiring information related to a purpose of use of a passenger cabin part, the purpose of use being intended by a user who rides in the passenger cabin part; and setting a control parameter of a traveling part that carries the passenger cabin part, based on information related to a behavior of the user in the passenger cabin part, and on the information related to the purpose of use intended by the user.

Yet another aspect of the present disclosure is a program that causes a computer to execute the information processing method, or a storage medium that stores the program in a non-transitory manner.

According to the present disclosure, it is possible to restrain hindering of an action of a user in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of an autonomous driving system according to an embodiment;

FIG. 2 is a block diagram schematically showing an example of respective configurations of a passenger cabin part, a traveling part, a user terminal, and a server included in the autonomous driving system according to the embodiment;

FIG. 3 shows an example of a functional configuration of the server;

FIG. 4 illustrates a table structure of user information;

FIG. 5 illustrates a table structure of passenger cabin part information;

FIG. 6 illustrates a table structure of traveling part information;

FIG. 7 illustrates a table structure of control parameter information;

FIG. 8 shows an example of a functional configuration of the traveling part;

FIG. 9 shows an example of a functional configuration of the passenger cabin part;

FIG. 10 shows an example of a functional configuration of the user terminal;

FIG. 11 is a sequence chart showing processing in the autonomous driving system;

FIG. 12 is an example of a flowchart of processing at the server, according to the embodiment;

FIG. 13 is an example of a flowchart of processing at the traveling part at a time of traveling, according to the embodiment;

FIG. 14 shows processing in step S209 in more detail;

FIG. 15 is an example of a flowchart of processing for transmitting behavior information, according to the embodiment;

FIG. 16 is an example of a flowchart of processing for transmitting a request for use from the user terminal, according to the embodiment; and

FIG. 17 shows an example of a screen, displayed on an output section of the user terminal, for allowing input of a user ID, a destination, and a purpose of use.

### DETAILED DESCRIPTION OF EMBODIMENTS

An information processing apparatus that is an aspect of the present disclosure sets a control parameter of a traveling part. The control parameter is, for example, a parameter affecting acceleration of the traveling part. The acceleration includes acceleration-deceleration in a traveling direction (front-back direction) of the traveling part, acceleration in a lateral direction (right-left direction) (lateral acceleration) relative to the traveling direction of the traveling part, and acceleration in a vertical direction (up-down direction) (vertical acceleration) relative to the traveling direction of the traveling part. Note that the information processing apparatus may be included, for example, in the traveling part, or in a server. The traveling part is, for example, an autonomous traveling vehicle. The traveling part can be joined to a passenger cabin part and, in a state of being joined to the passenger cabin part, can carry the passenger cabin part. The passenger cabin part may include a facility according to a purpose of use intended by a user. The traveling part is capable of traveling even in a state of not being joined to the passenger cabin part. The traveling part can be joined to a passenger cabin part according to a purpose of use intended by a user and can carry the passenger cabin part.

A control section acquires information related to a purpose of using a passenger cabin part (purpose of use) intended by a user. The user can use, for the purpose of use, an action that can be performed within the passenger cabin part during travel. The purpose of use is, for example, doing makeup or training. A purpose of use handled by a passenger cabin part may be preset on each passenger cabin part. The purpose of use may be determined based on information provided from the user, or may be determined based on a type of the passenger cabin part.

The control section sets the control parameter of the traveling part that carries the passenger cabin part, based on information related to a behavior of the user in the passenger cabin part, and on the information related to the purpose of use intended by the user. A traveling state of the traveling part changes according to the control parameter. Depending on the traveling state, there is a possibility that an action of the user is hindered and the purpose of use intended by the user cannot be achieved. For example, in a case where the purpose of use intended by the user is doing makeup, makeup cannot be put on well in some cases, depending on the traveling state of the vehicle. In a case where the purpose of use intended by the user is training, a sufficient effect of training cannot be obtained in some cases because a load is not rightly applied to the user, depending on the traveling state of the vehicle. Accordingly, the control section sets the control parameter of the traveling part, based on the information related to the behavior of the user in the passenger cabin part. The information related to the behavior of the user is information related to a behavior of the user corresponding to the purpose of use, and is, for example, information based on which it can be determined whether or not the user is performing an action corresponding to the purpose of use. Thus, appropriate control parameters can be set when the action corresponding to the purpose of use intended by the user is being performed, and when such an action is not being performed, respectively. For example, when the user is performing the action corresponding to the purpose of use, such a control parameter that does not hinder the action is set, whereby hindering of the action of the user in the vehicle can be restrained. When the user is not performing the action corresponding to the purpose of use, a control parameter that prioritizes traveling of the traveling part can be set, and accordingly, speedier or more comfortable travel can be accomplished.

Hereinafter, embodiments of the present disclosure will be described based on the drawings. Configurations according to the embodiments below are shown for illustrative purposes, and the present disclosure is not limited to the configurations according to the embodiments. The embodiments below can be combined to an extent possible.

### First Embodiment

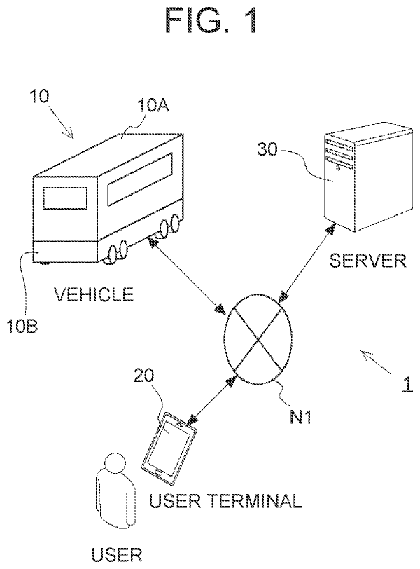

FIG. 1 shows a schematic configuration of an autonomous driving system 1 according to an embodiment. The autonomous driving system 1 includes, for example, a vehicle 10, a user terminal 20, and a server 30. The vehicle 10 includes, for example, a passenger cabin part 10A and a traveling part 10B. The passenger cabin part 10A and the traveling part 10B are detachable. The passenger cabin part 10A can be joined to a different traveling part 10B. The traveling part 10B can be joined to a different passenger cabin part 10A. The number of passenger cabin parts 10A and the number of traveling parts 10B are not limited to one as illustrated in FIG. 1, but may be two or larger. The traveling part 10B is a mobile object that can autonomously travel based on an operation command generated by the server 30. A user in FIG. 1 is a user who operates the user terminal 20, and is a user who requests use of a passenger cabin part 10A. In accordance with a content of an input made by the user into the user terminal 20, information related to a request for use of the passenger cabin part 10A is transmitted from the user terminal 20 to the server 30. A plurality of users may exist, and a plurality of user terminals 20 exist according to the number of the users.

The autonomous driving system 1 shown in FIG. 1 is a system in which when the user requests use of a passenger cabin part 10A, the server 30 offers the passenger cabin part 10A and the traveling part 10B. A plurality of users may share a ride in the passenger cabin part 10A. The user transmits the information related to the request for use of the passenger cabin part 10A to the server 30 via the user terminal 20. The information related to the request for use includes, for example, information related to a purpose of use intended by the user, information related to a destination of the user, and information related to a place of riding of the user. The information related to the purpose of use intended by the user includes, for example, information related to a predetermined action the user performs in the vehicle 10. Note that the predetermined action is not limited as long as the action can be performed within the vehicle 10. In the present embodiment, for the predetermined action, weight training (hereinafter, simply referred to as “training”) or doing makeup can be performed. The destination of the user is a destination of travel when the user desires to travel in a state of riding in the passenger cabin part 10A. The destination of the user may be a predetermined place (for example, a station). The place of riding of the user may be any one of a current position of the user terminal 20, a place desired by the user, and a predetermined place (for example, a station).

A plurality of types of passenger cabin parts 10A may exist according to purposes of use intended by users. For example, when a purpose of use intended by a user is doing makeup, a passenger cabin part 10A in which a seat and a mirror are arranged may handle the purpose of use. For example, when a purpose of use intended by a user is training, a passenger cabin part 10A in which training equipment is arranged may handle the purpose of use. The traveling part 10B can be joined to the passenger cabin part 10A and can carry the passenger cabin part 10A. The passenger cabin part 10A is made movable by being joined to the traveling part 10B. The passenger cabin part 10A can be moved by the traveling part 10B, with the user on board. The traveling part 10B is movable even in a state where the passenger cabin part 10A is not joined to the traveling part 10B. Note that although the passenger cabin part 10A and the traveling part 10B are vertically detachable in FIG. 1, a detaching direction is not limited to vertical, and the passenger cabin part 10A and the traveling part 10B may be detachable, for example, forward and backward or rightward and leftward relative to a traveling direction of the vehicle 10. A method for joining and a method for detaching the passenger cabin part 10A and the traveling part 10B are not limited.

When the server 30 receives the information related to the request for use of the vehicle 10 from the user terminal 20, the server 30 assigns the vehicle 10, for example, depending on the purpose of use intended by the user and the destination of the user. For example, a vehicle 10 is assigned that travels via the place of riding and the destination of the user and that is fit for the purpose of use intended by the user. Note that when no vehicle 10 exists that travels via the place of riding and the destination of the user, a vehicle 10 that travels a route closest to the place of riding and the destination of the user may be assigned, and the route of the vehicle 10 may be changed such that the vehicle 10 travels via the place of riding and the destination of the user.

The passenger cabin part 10A, the traveling part 10B, the user terminal 20, and the server 30 are mutually connected via a network N1. The network N1 is, for example, a world-wide public communication network such as the Internet, or a WAN (Wide Area Network) or another communication network may be adopted. The network N1 may include a telephone communication network for mobile telephones or the like, and a wireless communication network of Wi-Fi (R) or the like.

Hardware Configurations

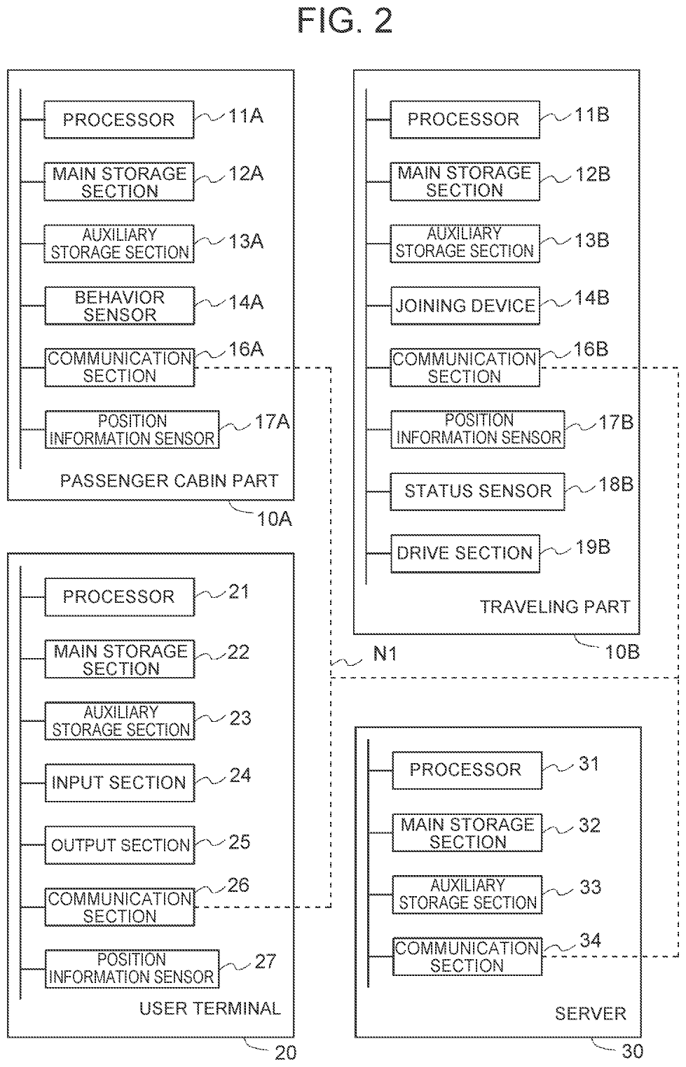

Hardware configurations of the passenger cabin part 10A, the traveling part 10B, the user terminal 20, and the server 30 will be described based on FIG. 2. FIG. 2 is a block diagram schematically showing an example of the respective configurations of the passenger cabin part 10A, the traveling part 10B, the user terminal 20, and the server 30 included in the autonomous driving system 1 according to the present embodiment.

The server 30 has a configuration of a general computer. The server 30 includes a processor 31, a main storage section 32, an auxiliary storage section 33, and a communication section 34. The sections and the like are mutually connected through a bus.

The processor 31 is a CPU (Central Processing Unit), a DSP (Digital Signal Processor), or the like. The processor 31 controls the server 30 and performs computation for various information processing. The processor 31 is an example of a “control section”. The main storage section 32 is a RAM (Random-Access Memory), a ROM (Read-Only Memory), or the like. The auxiliary storage section 33 is an EPROM (Erasable Programmable ROM), a hard disk drive (HDD), a removable medium, or the like. The auxiliary storage section 33 stores an operating system (OS), various programs, various tables, and the like. The processor 31 loads the programs stored in the auxiliary storage section 33 on a work area of the main storage section 32 and executes the programs, and each constituent section or the like is controlled through the execution of the programs. Thus, the server 30 implements a function matching with a predetermined objective. The main storage section 32 and the auxiliary storage section 33 are computer-readable recording media. Note that the server 30 may be a single computer, or may be a plurality of computers operating in coordination with each other. Information stored in the auxiliary storage section 33 may be stored in the main storage section 32. Information stored in the main storage section 32 may be stored in the auxiliary storage section 33.

The communication section 34 is means for communicating with the passenger cabin part 10A, the traveling part 10B, and the user terminal 20 via the network N1. The communication section 34 includes, for example, a LAN (Local Area Network) interface board and a wireless communication circuit for wireless communication. The LAN interface board and the wireless communication circuit are connected to the network N1.

Note that a series of processing performed by the server 30 can be executed by hardware, but also can be executed by using software. The hardware configuration of the server 30 is not limited to the configuration shown in FIG. 2. Part or the whole of the configuration of the server 30 may be included in the passenger cabin part 10A, the traveling part 10B, or the user terminal 20.

Next, the traveling part 10B will be described. The traveling part 10B includes a processor 11B, a main storage section 12B, an auxiliary storage section 13B, a joining device 14B, a communication section 16B, a position information sensor 17B, a status sensor 18B, and a drive section 19B. The sections and the like are mutually connected through a bus. The processor 11B, the main storage section 12B, the auxiliary storage section 13B, and the communication section 16B of the traveling part 10B are similar to the processor 31, the main storage section 32, the auxiliary storage section 33, and the communication section 34 of the server 30, and therefore a description thereof is omitted. The processor 11B is an example of the “control section”.

The joining device 14B is a device that joins and detaches the passenger cabin part 10A and the traveling part 10B, based on a control command generated by the processor 11B. The joining device 14B includes, for example, an electromagnet, a slope, a rail, a crane, or the like for joining the passenger cabin part 10A to the traveling part 10B. For example, the joining device 14B includes an actuator, and the actuator operates when the passenger cabin part 10A is joined to or detached from the traveling part 10B. Note that a method for joining and a method for detaching the passenger cabin part 10A and the traveling part 10B are not limited.

The communication section 16B is communication means for connecting the traveling part 10B to the network N1. The communication section 16B is, for example, a circuit for performing communication with another apparatus (for example, the server 30, the passenger cabin part 10A, or the like) via the network N1 by using a mobile communication service (for example, a telephone communication network of 5G (5th Generation), 4G (4th Generation), 3G (3rd Generation), LTE (Long Term Evolution), or the like), or wireless communication such as Wi-Fi (R) or Bluetooth (R).

The position information sensor 17B acquires position information (for example, a latitude, a longitude) on the traveling part 10B at a predetermined cycle. The position information sensor 17B is, for example, a GPS (Global Positioning System) reception section, a wireless communication section, or the like. The information acquired by the position information sensor 17B is, for example, recorded in the auxiliary storage section 13B or the like and transmitted to the server 30.

The status sensor 18B is means for sensing a state of the traveling part 10B or sensing surroundings of the traveling part 10B. Examples of the sensor for sensing the state of the traveling part 10B include an acceleration sensor, a speed sensor, a steering angle sensor, and an azimuth sensor. Examples of the sensor for sensing the surroundings of the traveling part 10B include a stereo camera, a laser scanner, a LIDAR, a radar, and the like.

The drive section 19B includes a mechanism that causes the traveling part 10B to autonomously travel based on a control command generated by the processor 11B.

The drive section 19B includes a mechanism that can adjust the acceleration-deceleration, the lateral acceleration, or the vertical acceleration of the traveling part 10B. The drive section 19B includes, for example, a motor or an internal combustion engine for driving wheels, an inverter, a brake mechanism, a damper mechanism, a steering mechanism, or the like. The drive section 19B is controlled in accordance with the control command, whereby autonomous traveling of the traveling part 10B is implemented.

Next, the passenger cabin part 10A will be described. The passenger cabin part 10A includes a processor 11A, a main storage section 12A, an auxiliary storage section 13A, a behavior sensor 14A, a communication section 16A, and a position information sensor 17A. The sections and the like are mutually connected via a bus.

The processor 11A, the main storage section 12A, the auxiliary storage section 13A, the communication section 16A, and the position information sensor 17A of the passenger cabin part 10A are similar to the processor 11B, the main storage section 12B, the auxiliary storage section 13B, the communication section 16B, and the position information sensor 17B of the traveling part 10B, and therefore a description thereof is omitted.

The behavior sensor 14A is a sensor that senses a behavior of the user in the passenger cabin part 10A, and is, for example, a camera that picks up an image within the passenger cabin part 10A. The camera picks up the image, for example, by using an imaging device such as a CCD (Charge Coupled Device) image sensor or a CMOS (Complementary Metal Oxide Semiconductor) image sensor. Picked-up image data can be transmitted to the traveling part 10B or the server 30 via the communication section 16A.

Next, the user terminal 20 will be described. The user terminal 20 is, for example, a small computer such as a smartphone, a mobile telephone, a tablet terminal, a personal information terminal, a wearable computer (a smartwatch or the like), or a personal computer (PC). The user terminal 20 includes a processor 21, a main storage section 22, an auxiliary storage section 23, an input section 24, an output section 25, a communication section 26, and a position information sensor 27. The sections and the like are mutually connected via a bus. The processor 21, the main storage section 22, the auxiliary storage section 23, the communication section 26, and the position information sensor 27 of the user terminal 20 are similar to the processor 11B, the main storage section 12B, the auxiliary storage section 13B, the communication section 16B, and the position information sensor 17B of the traveling part 10B, and therefore a description thereof is omitted.

The input section 24 is means for receiving an input operation made by the user, and is, for example, a touch panel, a keyboard, a mouse, a push button, or the like. The output section 25 is means for presenting information to the user, and is, for example, an LCD (Liquid Crystal Display), an EL (Electroluminescence) panel, a speaker, a lamp, or the like. The input section 24 and the output section 25 may be configured as a single touch panel display.

Functional Configuration: Server

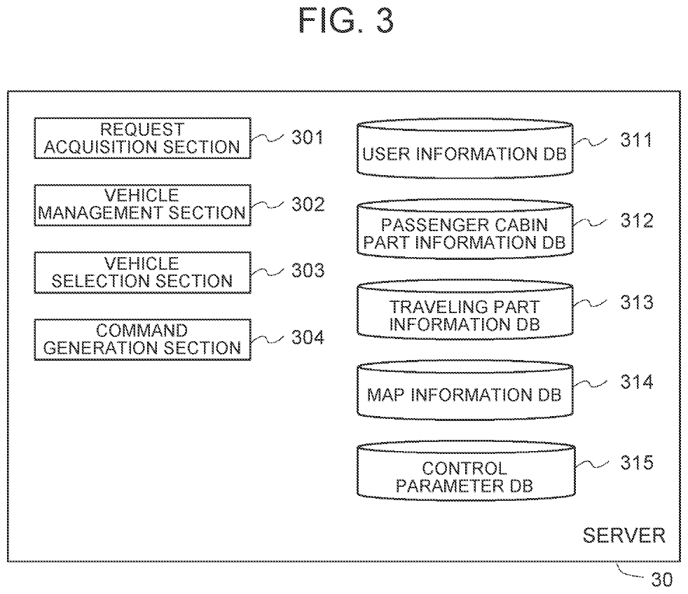

FIG. 3 shows an example of a functional configuration of the server 30. The server 30 includes, as functional constituent elements, a request acquisition section 301, a vehicle management section 302, a vehicle selection section 303, a command generation section 304, a user information DB 311, a passenger cabin part information DB 312, a traveling part information DB 313, a map information DB 314, and a control parameter DB 315. The request acquisition section 301, the vehicle management section 302, the vehicle selection section 303, and the command generation section 304 are functional constituent elements, for example, provided in such a manner that the processor 31 of the server 30 executes the various programs stored in the auxiliary storage section 33.

The user information DB 311, the passenger cabin part information DB 312, the traveling part information DB 313, the map information DB 314, and the control parameter DB 315 are, for example, relational databases constructed in such a manner that a database management system (DBMS) program executed by the processor 31 manages data stored in the auxiliary storage section 33. Note that any of the functional constituent elements of the server 30, or part of processing performed by the functional constituent elements of the server 30, may be implemented or performed by another computer connected to the network N1.

The request acquisition section 301 acquires, for example, a request for use transmitted from the user terminal 20. The request for use is information for the user to request use of the passenger cabin part 10A and the traveling part 10B. The request for use includes, for example, information related to a current position of the user (position information on the user), information related to a destination of the user, and information related to a purpose of use intended by the user. The current position of the user may be a place of riding of the user. The request for use is generated at the user terminal 20 in such a manner that the user makes a predetermined input into the input section 24 of the user terminal 20. The request acquisition section 301 stores the information related to the current position, the information related to the destination, and the information related to the purpose of use included in the request for use into the user information DB 311, which will be described later, in association with a user ID.

The vehicle management section 302 manages various information related to the passenger cabin part 10A and the traveling part 10B. The vehicle management section 302 manages, for example, a current position and a destination of each of the passenger cabin part 10A and the traveling part 10B. The current position and the destination are represented, for example, by a latitude and a longitude. The vehicle management section 302 acquires and manages, for example, position information transmitted from the passenger cabin part 10A at a predetermined cycle, or position information transmitted from the passenger cabin part 10A in response to a request from the server 30. Moreover, the vehicle management section 302 acquires and manages, for example, position information transmitted from the traveling part 10B at a predetermined cycle, or position information transmitted from the traveling part 10B in response to a request from the server 30. Note that when the passenger cabin part 10A is joined to the traveling part 10B, the position information on the joined passenger cabin part 10A may be treated as the same as the position information on the traveling part 10B. When the passenger cabin part 10A is detached from the traveling part 10B, the position information on the passenger cabin part 10A may be treated as the same as the position information on the traveling part 10B at the time the passenger cabin part 10A is detached from the traveling part 10B. In such a manner, the position information sensor 17A of the passenger cabin part 10A can be omitted. The vehicle management section 302 stores the position information on the passenger cabin part 10A into the passenger cabin part information DB 312, in association with a passenger cabin part ID. The passenger cabin part ID is an identifier unique to the passenger cabin part 10A. The vehicle management section 302 stores the position information on the traveling part 10B into the traveling part information DB 313, which will be described later, in association with a traveling part ID. The traveling part ID is an identifier unique to the traveling part 10B.

Moreover, the vehicle management section 302 manages, for example, the destination of the traveling part 10B. The final destination of the traveling part 10B may be the destination of the user who uses the passenger cabin part 10A. The destination of the user is included in the request for use. When a plurality of users are riding in the passenger cabin part 10A, a destination of any one user may be the final destination of the traveling part 10B, and destinations of the other users may be stopover places via which the traveling part 10B travels. The destination of the traveling part 10B may be predetermined.

Further, the vehicle management section 302 manages the purpose of use intended by the user that is handled by the passenger cabin part 10A. A purpose of use intended by a user may be preset on each passenger cabin part 10A, or a purpose of use to be handled by the passenger cabin part 10A may be decided depending on a riding user. For example, the vehicle management section 302 may set a purpose of use intended by a user who first uses the passenger cabin part 10A, as the purpose of use handled by the passenger cabin part 10A. The vehicle management section 302 stores the handled purpose of use into the passenger cabin part information DB 312, in association with the passenger cabin part ID.

The vehicle selection section 303 selects a vehicle 10 to assign to the user. The vehicle selection section 303 selects a passenger cabin part 10A and a traveling part 10B, depending on the purpose of use intended by the user and the destination of the user. The vehicle selection section 303 selects the passenger cabin part 10A and the traveling part 10B that are fit for the purpose of use intended by the user, by accessing the user information DB 311, the passenger cabin part information DB 312, the traveling part information DB 313, and the map information DB 314. For example, the vehicle selection section 303 selects a vehicle 10 that has a planned travel route included in an area within a predetermined distance of each of the current position and the destination of the user, and that includes a passenger cabin part 10A handling the same purpose of use as the purpose of use intended by the user. Note that selection of a passenger cabin part 10A is avoided if the number of users who use the passenger cabin part 10A becomes equal to or larger than a predetermined number, based on the information in the passenger cabin part information DB 312. The predetermined number is, for example, a riding capacity of the passenger cabin part 10A. The vehicle selection section 303 may select a vehicle 10 that has a planned travel route included in the area within the predetermined distance of each of the current position and the destination of the user, and that includes a passenger cabin part 10A in which no other user is riding. The planned travel route is generated by the command generation section 304, which will be described later, based on the current position and the destination of the traveling part 10B, and on map information stored in the map information DB 314, which will be described later. Note that the predetermined distance is, for example, a distance suitable for ride-sharing, and the area within the predetermined distance is, for example, an area in the same city, town, village, or ward. In the description above, the vehicle 10 is described as a vehicle that can be shared for a ride, but, instead of such a vehicle, the vehicle 10 may be a vehicle that cannot be shared and allows only one person or one group to ride in.

When no traveling part 10B to which a passenger cabin part 10A is joined exists, a passenger cabin part 10A that is not joined to a traveling part 10B and a traveling part 10B to which no passenger cabin part 10A is joined are selected. At the time, for example, a passenger cabin part 10A and a traveling part 10B may be selected that are currently located within the predetermined distance of the current position of the user.

When a plurality of selectable vehicles 10 exist, for example, a vehicle 10 may be selected that has the shortest travel distance from the current position of a traveling part 10B of the vehicle 10 to the current position of the user, or a vehicle 10 that has a travel distance not larger than a predetermined distance may be selected at random. A vehicle 10 that brings lowest costs may also be selected.

The vehicle selection section 303 inputs the number of users riding in the selected passenger cabin part 10A into the passenger cabin part information DB 312, which will be described later. When the passenger cabin part 10A and the traveling part 10B are a newly created pair, the vehicle selection section 303 updates the passenger cabin part information DB 312 and the traveling part information DB 313, which will be describe later, such that the pair can be identified.

The command generation section 304 generates an operation command that is a command to operate the traveling part 10B. The command generation section 304 generates the operation command, for example, such that users having the same purposes of use share a ride. The operation command includes, for example, a travel route of the traveling part 10B. The command generation section 304 generates the operation command, for example, such that the traveling part 10B departs from the current position (for example, a base), is joined to the passenger cabin part 10A at a place where the passenger cabin part 10A is placed, and thereafter travels to the destination of the user. Note that a command may be included that, after the traveling part 10B travels to the destination of the user, causes the traveling part 10B to travel to a predetermined place and to be detached from the passenger cabin part 10A. By doing so, the traveling part 10B can carry, for another user, a passenger cabin part 10A that handles another purpose of use. The traveling part 10B may stand by on the spot until a command to carry another passenger cabin part 10A is received. The departure place and the destination of the traveling part 10B may be a predetermined departure place and a predetermined destination. The operation command to the traveling part 10B may be generated such that the traveling part 10B is joined to a predetermined passenger cabin part 10A at each predetermined time and travels a predetermined route.

When the passenger cabin part 10A is selected by the vehicle selection section 303, the command generation section 304 regenerates the travel route of the traveling part 10B such that the traveling part 10B travels via a current position and a destination of each user who uses the passenger cabin part 10A. The travel route is generated based on the current position and the destination of each user, and on the map information stored in the map information DB 314, which will be described later. The travel route is generated such that the travel route conforms to a predetermined rule, such as a route making the shortest travel distance of the vehicle 10 or a route making the shortest travel time of the vehicle 10. The command generation section 304 stores information related to the generated travel route into the traveling part information DB 313 and transmits the information to the traveling part 10B.

The operation command includes information related to a control parameter of the traveling part 10B. Accordingly, when the traveling part 10B is selected by the vehicle selection section 303, the command generation section 304 generates the information related to the control parameter of the traveling part 10B. The control parameter is generated depending on the purpose of use intended by the user who rides in the passenger cabin part 10A. Note that when the passenger cabin part 10A is selected from among a plurality of types of passenger cabin parts 10A depending on the purpose of use intended by the user, the information related to the control parameter may be generated depending on a type of the passenger cabin part 10A. The information related to the control parameter is generated, for example, for a control parameter used when the user is performing a predetermined action and for a control parameter used when the user is not performing the predetermined action, respectively. The predetermined action is an action corresponding to the purpose of use. For example, when the user is performing the predetermined action, the control parameter of the traveling part 10B is generated such that the acceleration of the vehicle 10 is less than when the user is not performing the predetermined action. The acceleration can include the lateral acceleration or the vertical acceleration. For example, respective control parameters are set such that the acceleration changed through control of the internal combustion engine or the motor, the deceleration changed through control of the brake mechanism, the lateral acceleration changed through control of the steering mechanism, or the vertical acceleration changed through control of the damper mechanism is less when the user is performing the predetermined action, than when the user is not performing the predetermined action. Here, the acceleration is made less by limiting a maximum value of the acceleration.

For example, when the purpose of use intended by the user is doing makeup in the passenger cabin part 10A, the information related to the control parameter may be generated such that the control parameter have different values between when the user is putting on makeup and when the user is not putting on makeup. In such a case, the control parameter of the traveling part 10B is generated, for example, such that the acceleration of the vehicle 10 is less when the user is putting on makeup, than when the user is not putting on makeup. Note that “when the user is putting on makeup” refers to, for example, “when the user is performing an action of applying eyeliner” or “when the user is performing an action of applying lipstick”. When fast acceleration or the like occurs while the user is putting on makeup, the makeup may result in failure. Accordingly, the information related to the control parameter is generated such that fast acceleration or the like does not occur while the user is putting on makeup. When the user is not putting on makeup, since smooth travel is desired, the information related to the control parameter is generated such that smooth travel can be accomplished. As a result, the acceleration or the like occurring to the traveling part 10B is less when the user is putting on makeup, than when the user is not putting on makeup.

When the purpose of use intended by the user is training, similarly, the information related to the control parameter of the traveling part 10B is generated, for example, such that, in a case where the user performs training using a barbell in the passenger cabin part 10A, the acceleration of the vehicle 10 is less when the user is lifting the barbell, than when the user is not lifting the barbell. Also in such a case, the information related to the control parameter may be generated, for example, such that the acceleration of the traveling part 10B differs between when the user is performing training and when the user is not performing training. The control parameters are stored beforehand in the control parameter DB 315, which will be described later.

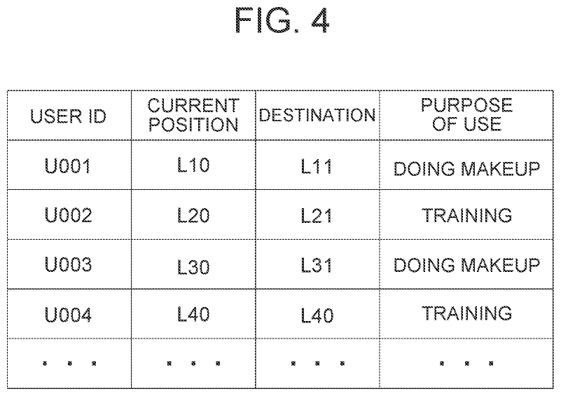

The user information DB 311 is formed in such a manner that user information is stored in the auxiliary storage section 33. The user information includes, for example, information related to a user ID associated with a user, a current position of the user, a destination of the user, and a purpose of use intended by the user. Here, a structure of the user information stored in the user information DB 311 will be described based on FIG. 4. FIG. 4 illustrates a table structure of the user information. The user information table includes respective fields of user ID, current position, destination, and purpose of use. In the user ID field, information for identifying a user or a user terminal 20 is input. In the current position field, information related to a current position of the user is input. The current position of the user may be any place input by the user into the user terminal 20, or may be a place based on a current position acquired from the user terminal 20. In the destination field, information related to a destination of the user is input. In the purpose-of-use field, information related to a purpose when the user uses a passenger cabin part 10A is input. The information related to each of the user ID, the current position, the destination, and the purpose of use is included in a request for use transmitted from the user terminal 20.

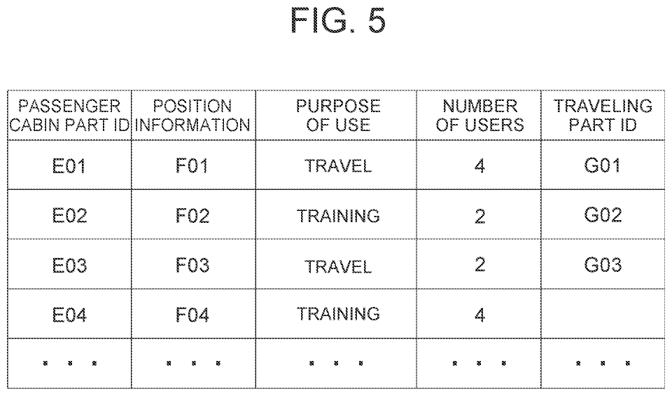

The passenger cabin part information DB 312 is formed in such a manner that information related to a passenger cabin part 10A (hereinafter, also referred to as “passenger cabin part information”) is stored in the auxiliary storage section 33. Here, a structure of the passenger cabin part information stored in the passenger cabin part information DB 312 will be described based on FIG. 5. FIG. 5 illustrates a table structure of the passenger cabin part information. The passenger cabin part information table includes respective fields of passenger cabin part ID, position information, purpose of use, number of users, and traveling part ID. In the passenger cabin part ID field, identification information for identifying a passenger cabin part 10A is input. In the position information field, position information on the passenger cabin part 10A is input. The position information is information indicating a current position of the passenger cabin part 10A. Note that when the passenger cabin part 10A is detached from a traveling part 10B, the current position of the passenger cabin part 10A may be fixed until the passenger cabin part 10A is next joined to a traveling part 10B. In the purpose-of-use field, information indicating what purpose the passenger cabin part 10A is used for is input. A purpose of use handled by each passenger cabin part 10A may be decided by a purpose of use intended by a first user, or may be predetermined. In the number-of-users field, information related to the number of users who use the passenger cabin part 10A is input. The number of users includes users who are riding and users who plan to ride in the passenger cabin part 10A. When the vehicle selection section 303 selects a passenger cabin part 10A fit for a user, one is added to a number input in the number-of-users field of the passenger cabin part information DB 312 corresponding to the passenger cabin part 10A. When the vehicle 10 arrives at a destination of a user, the vehicle selection section 303 subtracts one from a number input in the number-of-users field. In the traveling part ID field, identification information for identifying a traveling part 10B joined to the passenger cabin part 10A is input. Note that the traveling part ID field corresponding to a passenger cabin part 10A to which no traveling part 10B is joined is blank. When the vehicle selection section 303 newly pairs a passenger cabin part 10A with a traveling part 10B, the vehicle selection section 303 updates a traveling part ID associated with the passenger cabin part 10A in the passenger cabin part information DB 312.

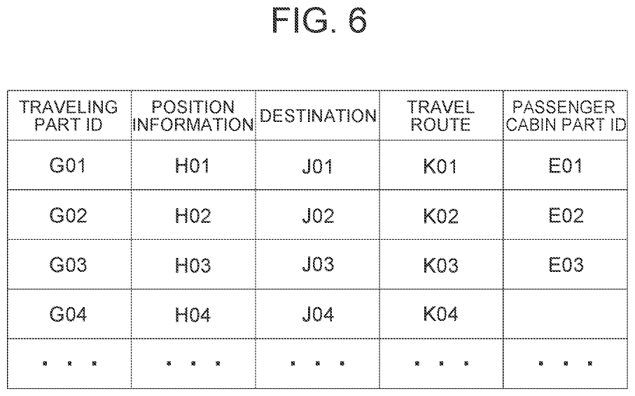

The traveling part information DB 313 is formed in such a manner that information related to a traveling part 10B (hereinafter, also referred to as “traveling part information”) is stored in the auxiliary storage section 33. A structure of the traveling part information stored in the traveling part information DB 313 will be described based on FIG. 6. FIG. 6 illustrates a table structure of the traveling part information. The traveling part information table includes respective fields of traveling part ID, position information, destination, travel route, and passenger cabin part ID. In the traveling part ID field, information for identifying a traveling part 10B is input. In the position information field, position information on the traveling part 10B is input. The position information is information indicating a current position of the traveling part 10B. In the destination field, information related to a destination of the traveling part 10B is input. The destination of the traveling part 10B is the final destination of the traveling part 10B. Note that the destination of the traveling part 10B may be any one of destinations of a plurality of riding users, or may be predetermined. In the travel route field, information related to a travel route of the traveling part 10B is input. The travel route is generated by the command generation section 304. In the passenger cabin part ID field, a passenger cabin part ID of a passenger cabin part 10A joined to the traveling part 10B is input. Note that the passenger cabin part ID field is blank when no passenger cabin part 10A is joined to the traveling part 10B. When the vehicle selection section 303 newly pairs a passenger cabin part 10A with a traveling part 10B, the vehicle selection section 303 updates a passenger cabin part ID associated with the traveling part 10B in the traveling part information DB 313.

The map information DB 314 stores the map information including map data and POI (Point of interest) information such as a character or a photograph indicating a characteristic of each point on the map data. Note that the map information DB 314 may be provided from another system, for example, a GIS (Geographic Information System), connected to the network N1.

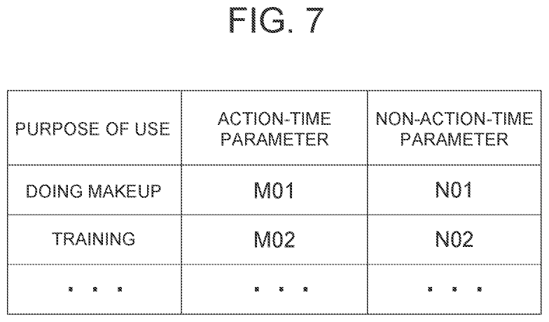

The control parameter DB 315 stores a control parameter of a traveling part 10B, according to a purpose of use intended by a user. Here, a structure of control parameter information stored in the control parameter DB 315 will be described based on FIG. 7. FIG. 7 illustrates a table structure of the control parameter information. The control parameter information table includes respective fields of purpose of use, action-time parameter, and non-action-time parameter. In the purpose-of-use field, information related to a purpose of use intended by a user is input. In the action-time parameter field, information related to a specifiable range of the control parameter of a traveling part 10B when an action corresponding to the purpose of use intended by the user is being performed is input. In the non-action-time parameter field, information related to a specifiable range of the control parameter of the traveling part 10B when the action corresponding to the purpose of use intended by the user is not being performed is input. The information is input beforehand in the control parameter DB 315. Each control parameter may indicate, for example, a specifiable upper limit value of the acceleration-deceleration, a specifiable upper limit value of the lateral acceleration, or a specifiable upper limit value of the vertical acceleration.

Since the acceleration-deceleration is related to, for example, output from the internal combustion engine or the motor, or braking intensity of the brake mechanism, an upper limit value of such output or braking intensity may be used for the control parameter. Since the lateral acceleration is related to, for example, an amount of change per unit time in steering angle in the steering mechanism, an upper limit value of the amount of change per unit time in steering angle in the steering mechanism may be used for the control parameter. Since the vertical acceleration is related to, for example, damping force of a damper, an upper limit value of the damping force of the damper may be used for the control parameter. For example, in a case where the acceleration is input as the control parameter, a value of the acceleration input in the action-time parameter field is smaller than a value of the acceleration input in the non-action-time parameter field. In the action-time parameter field, a value of the control parameter that is suitable when the user is performing a predetermined action may be input. In the non-action-time parameter field, for example, a value of the control parameter that is suitable for smooth traveling of the vehicle 10 may be input. Such values of the control parameter can be obtained beforehand through a test, simulation, or the like.

The acceleration-deceleration set as the control parameter may be indicated by another physical amount related to the acceleration-deceleration. For example, the acceleration-deceleration may be indicated by a brake fluid pressure, an amount of change per unit time in brake fluid pressure, a throttle valve opening degree for the internal combustion engine, an amount of change in throttle valve opening degree for the internal combustion engine, an amount of change per unit time in throttle valve opening degree for the internal combustion engine, or the like. The lateral acceleration set as the control parameter may be indicated by another physical amount related to the steering angle and the amount of change in steering angle. For example, the lateral acceleration set as the control parameter may be indicated by an amount of operation of a steering motor, or may be indicated by an amount of operation of the steering motor per unit time. The vertical acceleration set as the control parameter may be indicated by another physical amount related to the vertical acceleration. For example, the vertical acceleration set as the control parameter may be indicated by a damper fluid pressure, an amount of change per unit time in damper fluid pressure, or the like.

Functional Configuration: Traveling Part

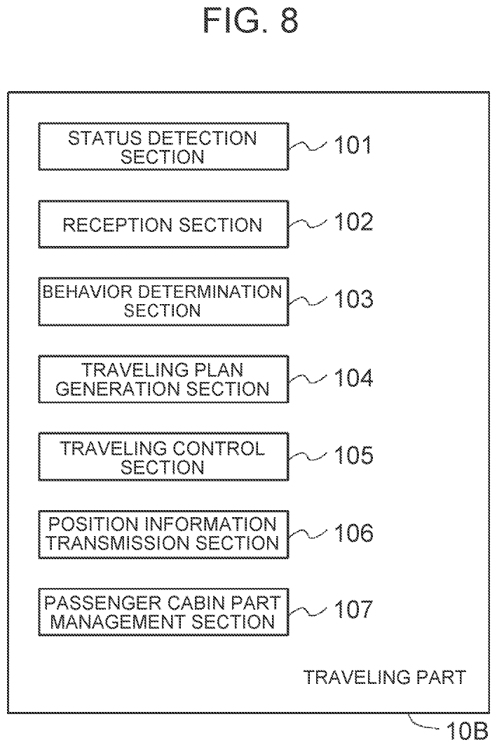

FIG. 8 shows an example of a functional configuration of the traveling part 10B. The traveling part 10B includes, as functional constituent elements, a status detection section 101, a reception section 102, a behavior determination section 103, a traveling plan generation section 104, a traveling control section 105, a position information transmission section 106, and a passenger cabin part management section 107. The status detection section 101, the reception section 102, the behavior determination section 103, the traveling plan generation section 104, the traveling control section 105, the position information transmission section 106, and the passenger cabin part management section 107 are functional constituent elements, for example, provided in such a manner that the processor 11B of the traveling part 10B executes various programs stored in the auxiliary storage section 13B.

The status detection section 101 detects a status of surroundings of the vehicle 10 or a status of the vehicle 10 required for autonomous traveling, based on data acquired by the status sensor 18B. Subjects to be detected include, but are not limited to, for example, the number and positions of lanes, the number and positions of other moving objects existing around the traveling part 10B, the number and positions of obstacles (for example, pedestrians, bicycles, structures, constructions, and the like) existing around the traveling part 10B, structure of roads, and road signs. Anything that is required for autonomous traveling can be a subject to be detected. For example, when the status sensor 18B is a stereo camera, detection of an object around the traveling part 10B is performed by image processing of image data picked up by the stereo camera. Data related to an environment surrounding the traveling part 10B (hereinafter, “environment data”) detected by the status detection section 101 is transmitted to the traveling control section 105, which will be described later. The status detection section 101 may detect, for example, a physical amount affecting an action of the user, such as the acceleration-deceleration, the lateral acceleration, the vertical acceleration of the traveling part 10B, the steering angle, the output from the internal combustion engine or the motor, the brake fluid pressure, or the damping force of the damper, and transmit the detected physical amount to the traveling control section 105.

The reception section 102 receives an operation command from the server 30. At the time, the reception section 102 acquires information related to control parameters included in the operation command. The reception section 102 receives information related to a behavior of the user from the passenger cabin part 10A. The control parameters included in the operation command acquired by the reception section 102 and the information related to the behavior of the user received by the reception section 102 are transmitted to the behavior determination section 103 or the traveling control section 105, which will be described later.

The behavior determination section 103 determines whether or not the user is performing a predetermined action, based on the information related to the behavior of the user received from the passenger cabin part 10A. The behavior determination section 103 determines whether or not the user is performing the predetermined action, for example, by analyzing an image picked up by the camera. For the determination, a known technique can be used. For example, the behavior determination section 103 may determine that the user is performing the predetermined action when an arm or a hand of the user is moved or bent in a predetermined direction. The behavior determination section 103 generates information related to whether or not the user is performing the predetermined action (hereinafter, also referred to as “behavior determination information”) and transmits the information to the traveling control section 105.

The traveling plan generation section 104 acquires an operation command from the server 30, and generates a traveling plan of the traveling part 10B. The operation command includes information related to a travel route of the traveling part 10B. The traveling plan generation section 104 calculates the travel route of the traveling part 10B based on the operation command given by the server 30 and generates the traveling plan for traveling along the travel route.

The traveling control section 105 generates a control command to control autonomous traveling of the traveling part 10B, based on the traveling plan generated by the traveling plan generation section 104, the environment data generated by the status detection section 101, position information on the traveling part 10B sensed by the position information sensor 17B, the behavior determination information generated by the behavior determination section 103, and the control parameters from the server 30 received by the reception section 102. For example, the traveling control section 105 generates a traveling locus for the traveling part 10B based on the environment data, and determines a value of the acceleration-deceleration of the traveling part 10B such that the traveling part 10B travels along the traveling locus. At the time, the traveling control section 105 selects either the action-time control parameter or the non-action-time control parameter, based on the behavior determination information. In other words, the action-time control parameter is selected when the user is performing the predetermined action, and the non-action-time control parameter is selected when the user is not performing the predetermined action. The traveling control section 105 determines the value of the acceleration-deceleration such that an upper limit value of the acceleration-deceleration set by the selected control parameter is not exceeded. Values of the lateral acceleration and the vertical acceleration can be similarly determined. The traveling control section 105 generates the control command such that the determined values of the acceleration-deceleration, the lateral acceleration, and the vertical acceleration are satisfied. Note that for a method of generating the control command to cause the traveling part 10B to autonomously travel, a known method can be adopted.

The position information transmission section 106 transmits the position information acquired from the position information sensor 17B to the server 30 via the communication section 16B. A timing at which the position information transmission section 106 transmits the position information can be set as appropriate. For example, the position information may be transmitted periodically, may be transmitted concurrently at the same timing of transmission of any information to the server 30, or may be transmitted in response to a request from the server 30. The position information transmission section 106 transmits the position information together with the traveling part ID to the server 30.

The passenger cabin part management section 107 generates a command related to joining and detachment between the passenger cabin part 10A and the traveling part 10B. The command includes a command to instruct the joining device 14B to perform an operation for joining the passenger cabin part 10A to the traveling part 10B, a command to instruct the joining device 14B to perform an operation for detaching the passenger cabin part 10A from the traveling part 10B, and the like.

Functional Configuration: Passenger Cabin Part

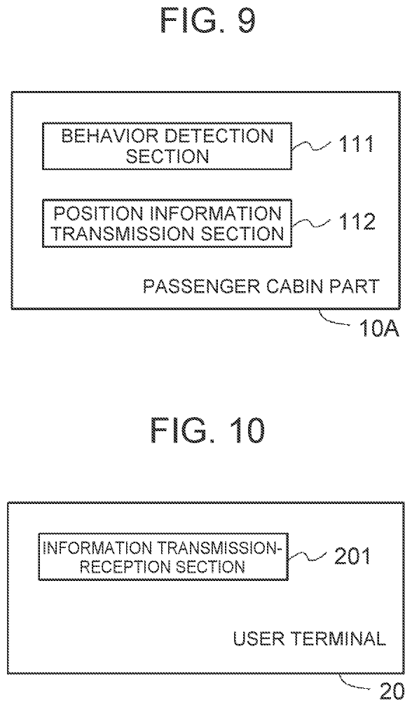

FIG. 9 shows an example of a functional configuration of the passenger cabin part 10A. The passenger cabin part 10A includes, as functional constituent elements, a behavior detection section 111 and a position information transmission section 112. The behavior detection section 111 and the position information transmission section 112 are functional constituent elements, for example, provided in such a manner that the processor 11A of the passenger cabin part 10A executes various programs stored in the auxiliary storage section 13A. The behavior detection section 111 transmits information related to a behavior of the user sensed by the behavior sensor 14A to the traveling part 10B. The behavior detection section 111 transmits, for example, picked-up image data acquired by the camera to the traveling part 10B.

The position information transmission section 112 transmits position information acquired from the position information sensor 17A to the server 30 via the communication section 16A. A timing at which the position information transmission section 112 transmits the position information can be set as appropriate. For example, the position information may be transmitted periodically, may be transmitted concurrently at the same timing of transmission of any information to the server 30, or may be transmitted in response to a request from the server 30. The position information transmission section 112 transmits the position information together with the passenger cabin part ID to the server 30.

Functional Configuration: User Terminal

FIG. 10 shows an example of a functional configuration of the user terminal 20. The user terminal 20 includes, as a functional constituent element, an information transmission-reception section 201. The information transmission-reception section 201 is a functional constituent element, for example, provided in such a manner that the processor 21 of the user terminal 20 executes various programs stored in the auxiliary storage section 23. The information transmission-reception section 201 controls, for example, transmission of information to the server 30 or reception of information from the server 30. The information transmission-reception section 201 generates a request for use, for example, when the user performs an action for using the passenger cabin part 10A. For example, the information transmission-reception section 201 displays a screen for making a request for use of the passenger cabin part 10A on the touch panel display of the user terminal 20 and, when the user taps the screen at a predetermined location, generates the request for use. The request for use includes position information on the user and a purpose of use intended by the user. The position information on the user may be acquired by the position information sensor 27, or may be input by the user via the input section 24. The purpose of use intended by the user may be input by the user via the input section 24. The information transmission-reception section 201 transmits the generated request for use in association with the user ID to the server 30.

Processing Flow: System

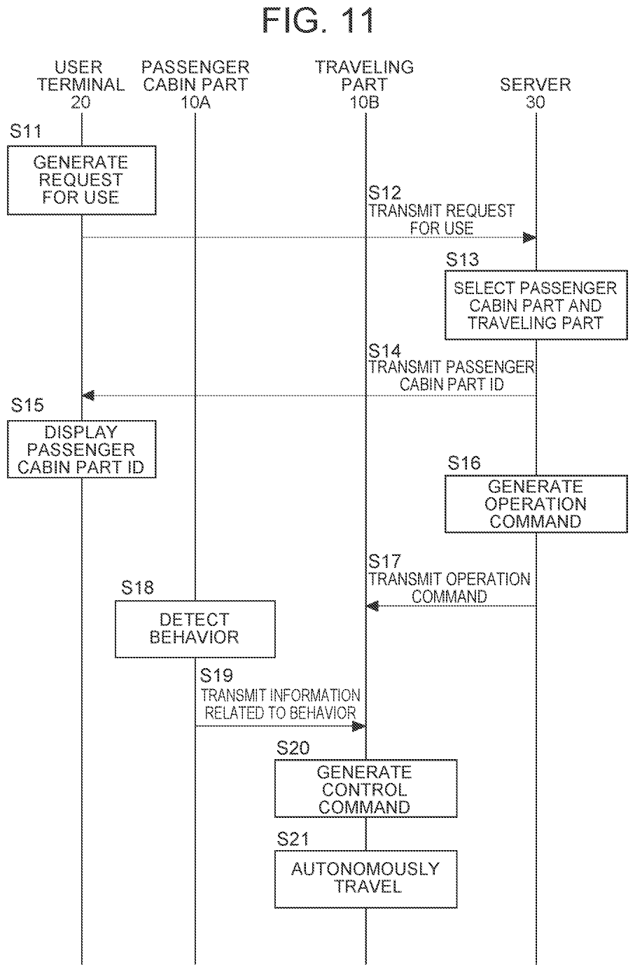

Next, overall processing in the autonomous driving system 1 will be described. FIG. 11 is a sequence chart showing the processing in the autonomous driving system 1. In FIG. 11, it is assumed that position information is transmitted from the user terminal 20, the passenger cabin part 10A, and the traveling part 10B to the server 30 at any time.

A request for use is generated at the user terminal 20 (S11), the request for use is transmitted from the user terminal 20 to the server 30 (S12), and then a pair of the passenger cabin part 10A and the traveling part 10B is selected at the server 30 (S13). Note that when the pair of the passenger cabin part 10A and the traveling part 10B does not exist, a new pair is created by individually selecting a passenger cabin part 10A and a traveling part 10B. When the passenger cabin part 10A is selected, the server 30 transmits the passenger cabin part ID to the user terminal 20 (S14). The user terminal 20 that has received the passenger cabin part ID causes the output section 25 to display the passenger cabin part ID (S15). Thus, the passenger cabin part 10A for the user to ride in is notified to the user.

The server 30 generates an operation command for the traveling part 10B (S16). At the time, control parameters corresponding to a purpose of use intended by the user are set and included in the operation command. The generated operation command is transmitted to the traveling part 10B (S17). At the passenger cabin part 10A, a behavior of the user is sensed by the behavior sensor 14A (S18), and information related to the behavior is transmitted to the traveling part 10B (S19). At the traveling part 10B that has received the operation command and the information related to the behavior, a control command is generated based on the operation command and the information related to the behavior (S20), and the traveling part 10B performs autonomous traveling based on the control command (S21). The processing from S18 to S21 are performed repeatedly. At the time, the processing in S18 and S19 may be performed only when a change occurs in the behavior of the user.

Processing Flow: Server

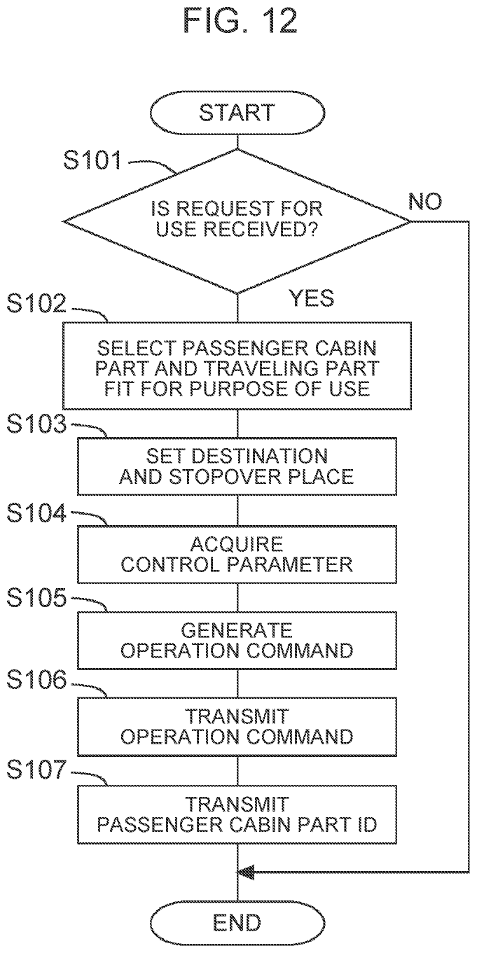

Next, processing at the server 30 will be described. FIG. 12 is an example of a flowchart of the processing at the server 30, according to the present embodiment. The processing shown in FIG. 12 is performed at each predetermined time by the processor 31 of the server 30. Here, it is assumed that the server 30 has already received information required to construct the passenger cabin part information DB 312 and the traveling part information DB 313.

In step S101, the request acquisition section 301 determines whether or not a request for use is received from a user terminal 20. The request for use includes information related to a current position of a user who uses a passenger cabin part 10A, information related to a destination of the user, and information related to a purpose of use intended by the user. When the request for use is received, the request acquisition section 301 stores the information included in the request for use into the user information DB 311, and makes a positive determination in step S101. The routine advances to step S102 when a positive determination is made in step S101, and the routine is terminated when a negative determination is made in step S101.

In step S102, the vehicle selection section 303 selects a passenger cabin part 10A and a traveling part 10B that are fit for the purpose of use intended by the user. The vehicle selection section 303 selects the passenger cabin part 10A and the traveling part 10B that are fit for the purpose of use intended by the user, by accessing the user information DB 311, the passenger cabin part information DB 312, the traveling part information DB 313, and the map information DB 314. The vehicle selection section 303 selects the traveling part 10B that has a planned travel route included in an area at a predetermined distance of the current position and the destination of the user, and that is joined to the passenger cabin part 10A handling the same purpose of use as the purpose of use intended by the user. At the time, selection of a passenger cabin part 10A is avoided if the number of users who use the passenger cabin part 10A becomes equal to or larger than a predetermined number, based on the information in the passenger cabin part information DB 312.

Further, the vehicle selection section 303 adds one to a number in the number-of-users field of the passenger cabin part information DB 312 corresponding to the passenger cabin part 10A. Note that in step S102, a passenger cabin part 10A and a traveling part 10B may be newly paired together. In such a case, the vehicle selection section 303 inputs a traveling part ID to be associated with the passenger cabin part 10A in the passenger cabin part information DB 312 and inputs a passenger cabin part ID to be associated with the traveling part 10B in the traveling part information DB 313.

Next, in step S103, the vehicle management section 302 sets each of a current position and a destination of each user as a stopover place via which the traveling part 10B travels, and sets the destination of any one user as a final destination of the traveling part 10B. At the time, the destination of a user that is farthest from a current position of the traveling part 10B may be set as the final destination of the traveling part 10B. When a final destination is predetermined, such a final destination is set. The vehicle management section 302 updates a destination in the traveling part information DB 313 corresponding to the traveling part 10B.

Next, in step S104, the command generation section 304 acquires control parameters of the traveling part 10B. The command generation section 304 acquires the purpose of use handled by the passenger cabin part 10A by referring to the passenger cabin part information DB 312, and subsequently acquires the control parameters (an action-time parameter and a non-action-time parameter) corresponding to the purpose of use by referring to the control parameter DB 315.

In step S105, the command generation section 304 generates an operation command including a travel route and the control parameters. The command generation section 304 generates the travel route of the traveling part 10B such that the traveling part 10B stops over at the current position of the traveling part 10B, the final destination, the current position of each user, and the destination of each user. When no passenger cabin part 10A is joined to the traveling part 10B, the travel route is generated such that the traveling part 10B travels from the current position of the traveling part 10B and first stops over at a current position of the passenger cabin part 10A. The travel route is generated based on the current position of the traveling part 10B, the final destination, the current position and the destination of each user, and the map information stored in the map information DB 314. The travel route is generated such as to be a route conforming to a predetermined rule. In addition to the travel route of the traveling part 10B, the operation command may include, for example, an indication that the traveling part 10B is joined to the passenger cabin part 10A at the current position of the passenger cabin part 10A, and an indication that a user is allowed to ride or alight at each stopover place.

Note that when a passenger cabin part 10A and a traveling part 10B is newly paired together in step S102, the operation command generated in step S105 includes a command to be joined to the passenger cabin part 10A at the current position of the passenger cabin part 10A (hereinafter, also referred to as “joining command”).

When the travel route is generated in step S105, the command generation section 304 updates a travel route in the traveling part information DB 313 corresponding to the traveling part 10B. In step S106, the command generation section 304 transmits the operation command including the control parameters and the generated travel route to the traveling part 10B. In step S107, the command generation section 304 transmits a passenger cabin part ID corresponding to the selected passenger cabin part 10A to the user terminal 20 that has transmitted the request for use.

Processing Flow: Traveling Part

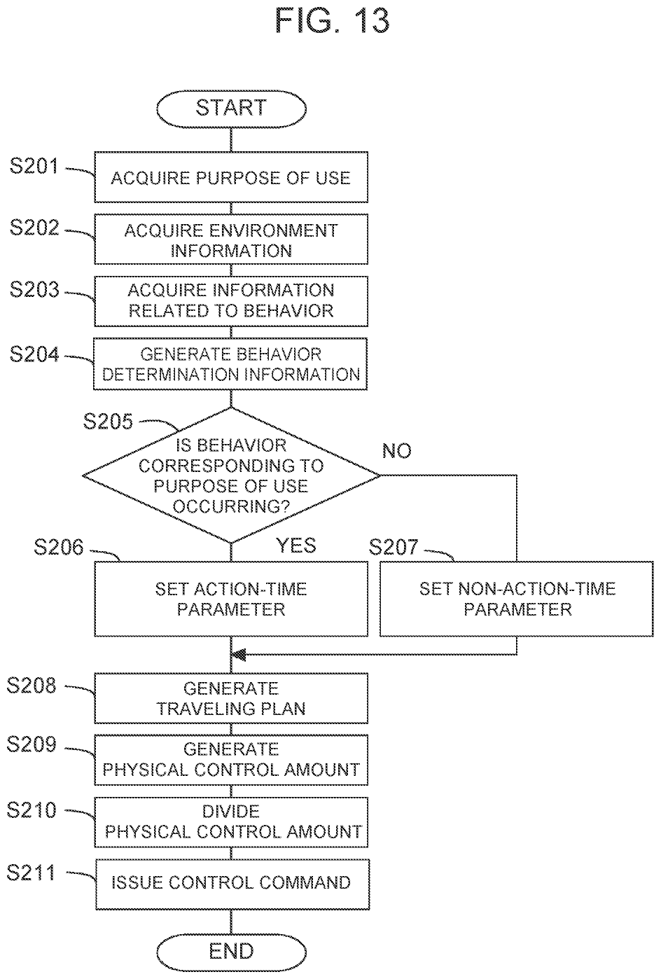

Next, processing at the traveling part 10B will be described. FIG. 13 is an example of a flowchart of processing at the traveling part 10B at a time of traveling, according to the present embodiment. The processing shown in FIG. 13 is performed at each predetermined time by the processor 11B of the traveling part 10B that has received an operation command.

In step S201, the reception section 102 acquires information related to a purpose of use intended by a user who is riding in the passenger cabin part 10A. The information related to the purpose of use intended by the user is included in the operation command received from the server 30. The reception section 102 may acquire the information related to the purpose of use intended by the user from the passenger cabin part 10A. For communication between the passenger cabin part 10A and the traveling part 10B, short-range wireless communication may be used. In step S202, the status detection section 101 acquires environment information. In step S203, the reception section 102 acquires information related to a behavior of the user from the passenger cabin part 10A.

Next, in step S204, the behavior determination section 103 generates behavior determination information, based on the information related to the behavior of the user received from the passenger cabin part 10A. In step S205, the traveling plan generation section 104 determines whether or not a behavior corresponding to the purpose of use is occurring in the passenger cabin part 10A. In other words, it is determined, based on the behavior determination information, whether or not the user is performing a predetermined action. The routine advances to step S206 when a positive determination is made in step S205, and the routine advances to step S207 when a negative determination is made in step S205.

In step S206, the traveling plan generation section 104 sets an action-time parameter as a control parameter. In step S207, the traveling plan generation section 104 sets a non-action-time parameter as a control parameter. The action-time parameter and the non-action-time parameter corresponding to the purpose of use are provided from the server 30 beforehand and stored in the auxiliary storage section 13B. Next, in step S208, the traveling plan generation section 104 generates a traveling plan. The traveling plan may include a traveling locus for the traveling part 10B, and may include information related to the acceleration-deceleration, the lateral acceleration, or the vertical acceleration of the traveling part 10B. The traveling plan may be generated, for example, based on a departure place, a stopover place, a destination, the map data, and the like.

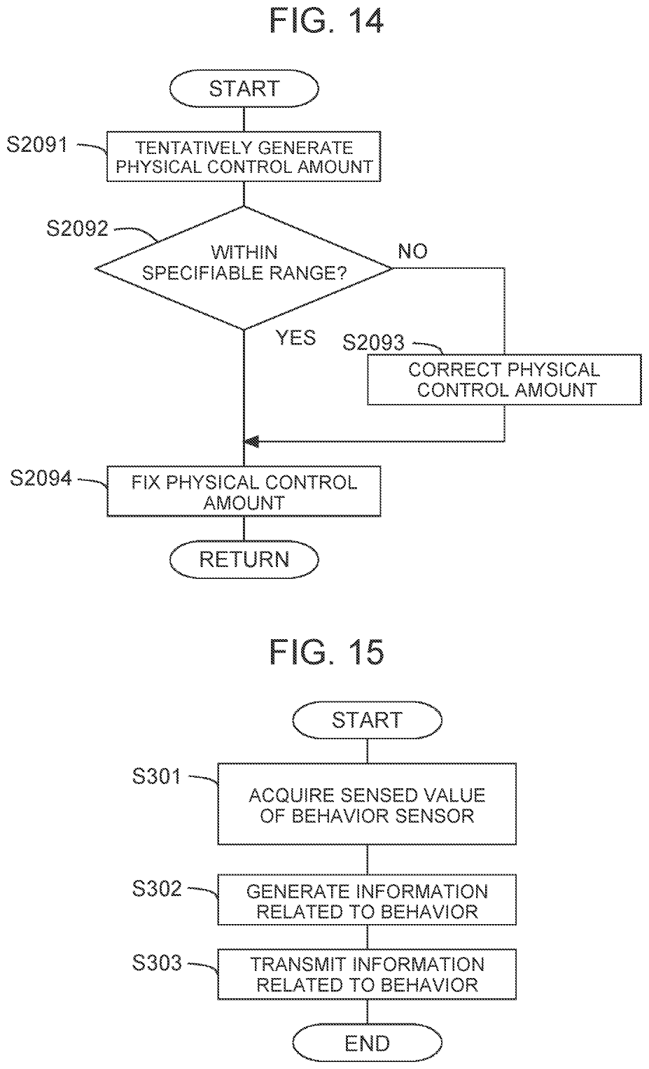

In step S209, the traveling control section 105 generates a physical control amount for implementing the traveling plan. Here, FIG. 14 shows the processing in step S209 in more detail. In the flowchart, a description will be given of a case of generating two types of physical control amount, namely, a physical control amount of acceleration-deceleration and a physical control amount of steering angle. First, in step S2091, the traveling control section 105 generates tentative values for the physical control amount of acceleration-deceleration and the physical control amount of steering angle. The then control amount of acceleration-deceleration and the then control amount of steering angle may be generated, for example, based on a preset parameter, such as a relationship between a speed of the traveling part 10B and a maximum steering angle, a relationship between a traveling environment and the acceleration-deceleration (steering angle), or a time period within which an operation (for example, a lane change) should be completed.

Next, in step S2092, the traveling control section 105 determines whether or not each generated physical control amount falls within a specifiable range. The specifiable range is obtained from the control parameter set in step S206 or step S207. When a positive determination is made in step S2092, the routine advances to step S2094, and the physical control amounts generated in step S2091 are fixed. When a negative determination is made in step S2092, the routine advances to step S2093, and the traveling control section 105 corrects the physical control amounts such that the control amount of acceleration-deceleration or the control amount of steering angle becomes an upper limit value in the specifiable range. Then in step S2094, the corrected physical control amounts are fixed.

Referring back to FIG. 13, in step S210, the traveling control section 105 divides each of the generated physical control amounts into a plurality of timesteps. For example, each timestep may be, but is not limited to, 100 milliseconds.

Next, in step S211, the traveling control section 105 issues a control command, based on a change in each of the physical control amounts from a current timestep to a next timestep. For example, when one timestep is 100 milliseconds and when +2.0 km/h/s is specified as acceleration-deceleration, a command specifying a change in speed of 0.2 km/h per timestep is generated and issued. For example, when it is specified to change the steering angle to 20 degrees in two seconds, a command specifying a change in steering angle of 0.1 degrees per timestep is generated and issued.

Processing Flow: Passenger Cabin Part

Next, processing at the passenger cabin part 10A for transmitting information related to a behavior of a user will be described. FIG. 15 is an example of a flowchart of the processing for transmitting behavior information, according to the present embodiment. The processing shown in FIG. 15 is performed at each predetermined time by the processor 11A of the passenger cabin part 10A.

In step S301, the behavior detection section 111 acquires a sensed value of the behavior sensor 14A. In step S302, the behavior detection section 111 generates information related to a behavior, based on the sensed value of the behavior sensor 14A. In step S303, the behavior detection section 111 transmits the information related to the behavior to the traveling part 10B.

Processing Flow: User Terminal

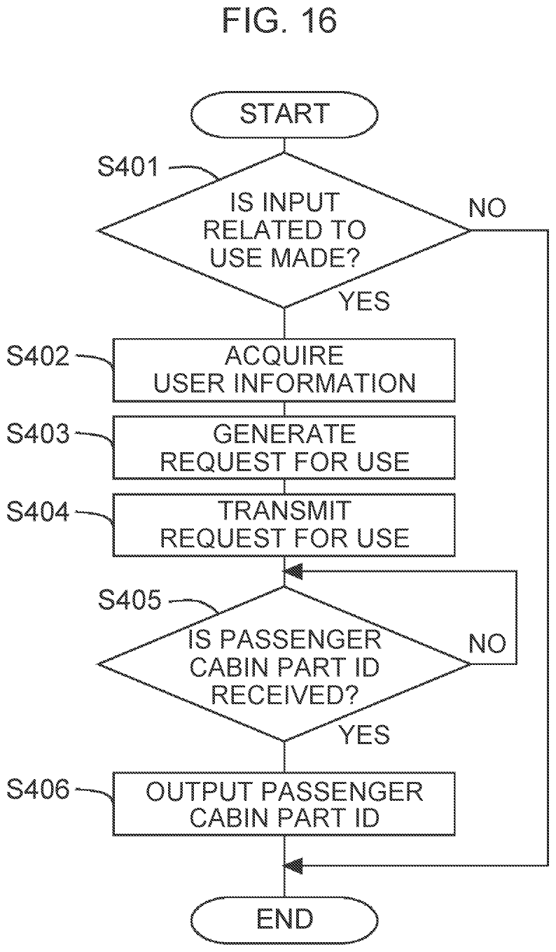

Next, processing for transmitting a request for use from the user terminal 20 will be described. FIG. 16 is an example of a flowchart of the processing for transmitting the request for use from the user terminal 20, according to the present embodiment. The processing shown in FIG. 16 is performed at each predetermined time by the processor 21 of the user terminal 20.

In step S401, the information transmission-reception section 201 determines whether or not an input related to use of a passenger cabin part 10A is made into the input section 24. The information transmission-reception section 201 determines that an input related to use of a passenger cabin part 10A is made, for example, when the user performs an operation such as tapping at a predetermined location on a screen, output on the output section 25, for transmission of a request for use. The screen for transmission of a request for use is, for example, displayed on the touch panel display, and the information transmission-reception section 201 determines whether or not the user taps the screen at the predetermined location. Note that transmission of a request for use is not limited to when the screen is tapped at the predetermined location. The routine advances to step S402 when a positive determination is made in step S401, and the routine is terminated when a negative determination is made in step S401.

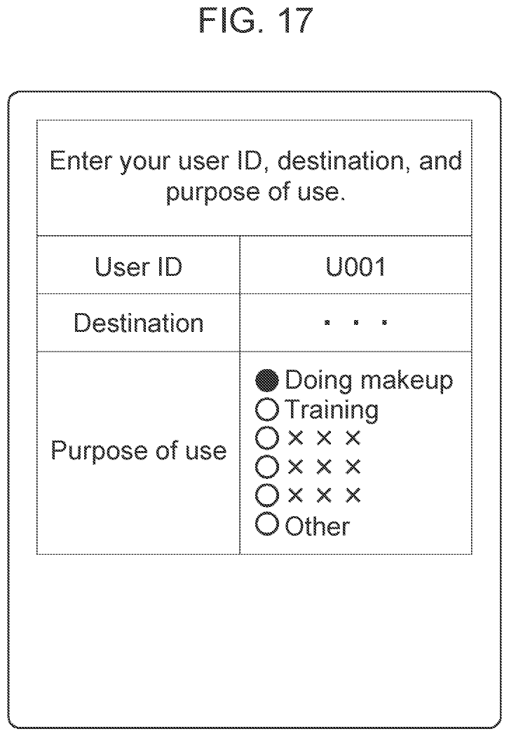

In step S402, the information transmission-reception section 201 acquires user information. The information transmission-reception section 201 acquires position information on the user terminal 20, based on the position information sensor 27. The information transmission-reception section 201 causes the output section 25 to display a screen prompting the user to input a user ID, a destination, and a purpose of use. Here, FIG. 17 shows an example of the screen, displayed on the output section 25 of the user terminal 20, for allowing input of a user ID, a destination, and a purpose of use. For the user ID and the destination, the user inputs characters. The user ID may be preset as a unique value to the user terminal 20. For the destination, an address or a facility name may be input. A plurality of preset places may be displayed, so that the user can select a destination from among the places. The purpose of use is selected in such a manner that the user taps on one of prepared button icons. Referring back to FIG. 16, in step S403, the information transmission-reception section 201 generates a request for use. In step S404, the information transmission-reception section 201 transmits the request for use to the server 30.

Next, in step S405, the information transmission-reception section 201 determines whether or not a passenger cabin part ID is received from the server 30. The passenger cabin part ID received here is a passenger cabin part ID corresponding to a passenger cabin part 10A to be used by the user. The routine advances to step S406 when a positive determination is made in step S405, and step S405 is performed again when a negative determination is made in step S405. In step S406, the information transmission-reception section 201 outputs the passenger cabin part ID to the output section 25. Thus, the user can come to know the passenger cabin part 10A to ride in.

As described hereinabove, according to the present embodiment, a vehicle 10 fit for a purpose of use intended by a user can be provided to the user. Since a control parameter of a traveling part 10B differs between when an action corresponding to the purpose of use intended by the user is being performed in a passenger cabin part 10A and when such an action is not being performed in the passenger cabin part 10A, the user can be encouraged to perform the action corresponding to the purpose of use in the passenger cabin part 10A. Thus, user convenience is enhanced. When the user is not performing the action corresponding to the purpose of use, the traveling part 10B can be operated more smoothly, and consequently, for example, the user can arrive at the destination more quickly.

### Other Embodiments

The above-described embodiment is only an example, and the present disclosure can be implemented with changes made as appropriate without departing from the gist and scope of the present disclosure.

The processing and means described in the present disclosure can be performed and implemented by being freely combined to the extent that no technical contradiction occurs.

The processing described as being performed by a single apparatus may be shared among and performed by a plurality of apparatuses. Alternatively, the processing described as being performed by different apparatuses may be performed by a single apparatus. In a computer system, it can be flexibly changed what hardware configuration (server configuration) is used to implement each function.

Although the server 30 includes, as functional constituent elements, the request acquisition section 301, the vehicle management section 302, the vehicle selection section 303, the command generation section 304, the user information DB 311, the passenger cabin part information DB 312, the traveling part information DB 313, the map information DB 314, and the control parameter DB 315 in the above-described embodiment, one or some, or all, of such functional constituent elements may be included in the passenger cabin part 10A, the traveling part 10B, or the user terminal 20. For example, the control parameter DB 315 may be included in the traveling part 10B. In such a case, it is not necessary to transmit the control parameters from the server 30 to the traveling part 10B.

Although the traveling part 10B includes the behavior determination section 103 in the above-described embodiment, instead of such a configuration, the passenger cabin part 10A may include the behavior determination section 103. A determination result made by the behavior determination section 103 may be transmitted from the passenger cabin part 10A to the traveling part 10B. Moreover, although the information related to the behavior of the user is transmitted from the passenger cabin part 10A directly to the traveling part 10B, instead of such a configuration, the information related to the behavior of the user may be transmitted from the passenger cabin part 10A to the traveling part 10B via the server 30.

Note that actions in the passenger cabin part 10A also include a case where a user is doing nothing, such as sleeping, and a passive action. Examples of the passive action include receiving massage or medical treatment. A plurality of types of passenger cabin parts 10A may be set correspondingly to a plurality of actions, and an operation command may be generated such that users having the same purposes of use ride in a passenger cabin part 10A fit for the users.

The present disclosure can also be implemented in such a manner that a computer program packaging the functions described in the embodiment is provided to a computer, and one or more processors included in the computer read and execute the program. Such a computer program may be provided to the computer by using a non-transitory computer-readable storage medium capable of connecting to a system bus of the computer, or may be provided to the computer via a network. Examples of the non-transitory computer-readable storage medium include any types of disks and discs, such as magnetic disks (floppy (R) disk, hard disk drive (HDD), and the like) and optical discs (CD-ROM, DVD disc, Blu-ray Disc, and the like), a read-only memory (ROM), a random-access memory (RAM), an EPROM, an EEPROM, a magnetic card, a flash memory, an optical card, and any types of media suitable for storing electronic instructions.

What is claimed is:

1. An information processing apparatus, comprising a control section that performs:
acquiring information related to a purpose of use of a passenger cabin part, the purpose of use being intended by a user who rides in the passenger cabin part; and
setting a control parameter of a traveling part that carries the passenger cabin part, based on information related to a behavior of the user in the passenger cabin part, and on the information related to the purpose of use intended by the user.

2. The information processing apparatus according to claim 1, wherein the control section determines whether or not the user is performing an action corresponding to the purpose of use, based on the information related to the behavior of the user in the passenger cabin part.

3. The information processing apparatus according to claim 2, wherein the control section sets the control parameter to different values between when the user is performing the action corresponding to the purpose of use and when the user is not performing the action corresponding to the purpose of use.

4. The information processing apparatus according to claim 2, wherein the control section sets the control parameter such that when the user is performing the action corresponding to the purpose of use, acceleration-deceleration of the traveling part is less than when the user is not performing the action corresponding to the purpose of use.

5. The information processing apparatus according to claim 2, wherein the control section sets the control parameter such that when the user is performing the action corresponding to the purpose of use, lateral acceleration of the traveling part is less than when the user is not performing the action corresponding to the purpose of use.

6. The information processing apparatus according to claim 2, wherein the control section sets the control parameter such that when the user is performing the action corresponding to the purpose of use, vertical acceleration of the traveling part is less than when the user is not performing the action corresponding to the purpose of use.

7. The information processing apparatus according to claim 2, wherein determining whether or not the user is performing the action corresponding to the purpose of use is performed based on a sensed value of a sensor that senses the behavior of the user in the passenger cabin part.

8. The information processing apparatus according to claim 1, wherein a plurality of types of the passenger cabin parts exist, and the purpose of use intended by the user is set on each of the passenger cabin parts.

9. A system, comprising:
a passenger cabin part in which a user rides;
a traveling part that is joined to the passenger cabin part and carries the passenger cabin part; and
a server that assigns the passenger cabin part and the traveling part to the user, wherein
the passenger cabin part includes a sensor that senses a behavior of the user,
the traveling part or the server sets a control parameter of the traveling part, depending on information related to the behavior of the user sensed by the sensor, and on information related to a purpose of use intended by the user, and
the traveling part performs autonomous traveling based on the control parameter.

10. The system according to claim 9, wherein the traveling part or the server determines whether or not the user is performing an action corresponding to the purpose of use, based on the information related to the behavior of the user sensed by the sensor.

11. The system according to claim 10, wherein the traveling part or the server sets the control parameter to different values between when the user is performing the action corresponding to the purpose of use and when the user is not performing the action corresponding to the purpose of use.

12. The system according to claim 10, wherein the traveling part or the server sets the control parameter such that when the user is performing the action corresponding to the purpose of use, acceleration-deceleration of the traveling part is less than when the user is not performing the action corresponding to the purpose of use.

13. The system according to claim 10, wherein the traveling part or the server sets the control parameter such that when the user is performing the action corresponding to the purpose of use, lateral acceleration of the traveling part is less than when the user is not performing the action corresponding to the purpose of use.

14. The system according to claim 10, wherein the traveling part or the server sets the control parameter such that when the user is performing the action corresponding to the purpose of use, vertical acceleration of the traveling part is less than when the user is not performing the action corresponding to the purpose of use.

15. The system according to claim 9, wherein a plurality of types of the passenger cabin parts exist, and the purpose of use intended by the user is set on each of the passenger cabin parts.

16. The system according to claim 9, wherein a plurality of types of the passenger cabin parts exist, and the server assigns a passenger cabin part fit for the purpose of use intended by the user, to the user.

17. The system according to claim 9, further comprising a terminal of the user, wherein the terminal of the user transmits information related to the purpose of use intended by the user to the traveling part or the server.

18. An information processing method, comprising:
by a computer,
acquiring information related to a purpose of use of a passenger cabin part, the purpose of use being intended by a user who rides in the passenger cabin part; and
setting a control parameter of a traveling part that carries the passenger cabin part, based on information related to a behavior of the user in the passenger cabin part, and on the information related to the purpose of use intended by the user.

19. The information processing method according to claim 18, further comprising determining whether or not the user is performing an action corresponding to the purpose of use, based on the information related to the behavior of the user in the passenger cabin part.

20. The information processing method according to claim 19, wherein the control parameter is set to different values between when the user is performing the action corresponding to the purpose of use and when the user is not performing the action corresponding to the purpose of use.
